(19) United States
(12) Patent Application Publication
(10) Pub. No.: US 2023/0146474 A1
(43) Pub. Date: May 11, 2023

(54) PURCHASE AND TRANSFER OF CRYPTOCURRENCY WITHOUT PREEXISTING WALLETS

(71) Applicants: Evite, Inc., Los Angeles, CA (US); Ember Fund, Inc., Los Angeles, CA (US)

(72) Inventors: David Yeom, Sherman Oaks, CA (US); Jason Woo, Burbank, CA (US); Alex Wang, Los Angeles, CA (US); Guillaume Torche, Venice, CA (US); Mario Cerdan Lazaro, Venice, CA (US)

(21) Appl. No.: 17/979,260

(22) Filed: Nov. 2, 2022

Related U.S. Application Data
(60) Provisional application No. 63/274,923, filed on Nov. 2, 2021.

(51) Int. Cl. G06Q 20/38; G06Q 20/36

(52) U.S. Cl. CPC G06Q 20/381; G06Q 20/3678; G06Q 2220/00

(57) ABSTRACT

Systems and method for purchasing of and transferring of cryptocurrency without preexisting cryptocurrency wallets use a first server to receive from a user computing device, a user-selected amount of United States Dollars (USD) from to purchase an exchanged amount of cryptocurrency to transfer to a recipient. In response to receiving the desired amount of USD, the first server trades the received user-selected amount of USD from for a desired amount of a stablecoin at a second server and transfers the desired amount of stablecoin to an existing custodial wallet to be held for the benefit of the recipient at the second server.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from U.S. provisional patent application number 63/274,923 entitled “CREATION AND TRANSFER OF CRYPTOCURRENCY WITHOUT PREEXISTING WALLETS” filed Nov. 2, 2021, the entire content of which is incorporated herein by reference.

### BACKGROUND

### Field

This disclosure relates to cryptocurrency and more particularly to the ability to purchase and transfer cryptocurrency without either the sender or the receiver possessing a cryptocurrency wallet.

### Description of the Related Art

Cryptocurrencies are rapidly growing in popularity among the more tech-savvy individuals worldwide. Tech entrepreneurs are investing heavily in the currencies and in technology surrounding those currencies. For example, non-fungible tokens (NFTs) have become remarkably popular wherein individuals may purchase the “one” version of a particular video, image, or event. The NBA® has begun selling numerous happenings from its video archives as NFTs.

Meanwhile, the infrastructure to enable these sales to take place has been growing simultaneously. For example, the Winklevoss twins, famous for early involvement in Facebook®, have subsequently founded one of the largest cryptocurrency exchanges and the Nifty Gateway (niftygateway.com) which has become one of the largest and most-successful auction houses/marketplaces for NFTs. Much like a Sotheby’s auction house, Nifty Gateway takes a small percentage of all NFTs sold on its marketplace.

Hedge funds and mutual funds (or their cryptocurrency equivalents) in cryptocurrency are starting or have been operating successfully for some time. However, the average individual has a great deal of fear of the stock market and financial matters generally. This is all the more reason why, as cryptocurrencies continue to converge with complex financial vehicles and technology, the average consumer can find them difficult, scary, or too complex to approach.

### DESCRIPTION OF THE DRAWINGS

The patent application file contains at least one drawing to be executed in color. Copies of this patent application publication with color drawings will be provided by the Office upon request and payment of the necessary fee.

FIG. 1 is an overview of a system for purchasing of and transferring of cryptocurrency without preexisting cryptocurrency wallets.

FIG. 2 is a block diagram of an exemplary computing device.

FIG. 3 is a functional block diagram of a system for purchasing of and transferring of cryptocurrency without preexisting cryptocurrency wallets.

FIGS. 4-8 are flowcharts of processes for purchasing of and transferring of cryptocurrency without preexisting cryptocurrency wallets.

Throughout this description, elements appearing in figures are assigned three-digit reference designators, where the most significant digit or digits is the figure number and the two least significant digits may be specific to the element. An element that is not described in conjunction with a figure may be presumed to have the same characteristics and function as a previously described element having a reference designator with the same least significant digits.

### DETAILED DESCRIPTION

Cryptocurrency can be extremely non-user-friendly. It is difficult for an average consumer to comprehend that there are no “accounts” as in typical banking. Instead, there are cryptocurrency wallets and associated cryptocurrency wallet addresses. A client of a given bank or credit card may be capable of memorizing their account number after years of use. These account numbers are typically shorter than 16 numbers. In contrast, cryptocurrency wallets are typically on the order of 34 alpha-numeric characters long. Very few cryptocurrency users memorize their wallet addresses, simply because they are so long. And, numbers of this sort are not even particularly well-suited to simply writing them down or accurately representing them on paper since they may have upper and lower case characters. A user storing these addresses in digital form, such as on a computer or cell-phone, exposes the user to undesirable security risks, such by a hacker obtaining the numbers.

Further, purchase and transfer of cryptocurrency requires knowledge of the cryptocurrency wallets and/or of the cryptocurrency wallet address of the user (e.g., sender) and of the recipient (e.g., redeemer). For example, a user’s purchase of cryptocurrency may require the user’s knowledge of a preexisting cryptocurrency wallet and wallet addresses of the user. Transferring of cryptocurrency may require the user’s knowledge of a preexisting recipient’s cryptocurrency wallet and wallet addresses of the recipient. Creating and/or using the user’s or recipient’s wallet or wallet address requires the user and/or recipient to input of the lengthy wallet address correctly.

Then, transferring to the recipient wallet requires knowing the recipient’s preexisting wallet address, knowledge that the recipient’s actual preexisting wallet and address have been created or otherwise exist so that funds may be transferred to it, and careful entry of that information to enable the transfer to take place. This is a convoluted process for most common consumers (e.g., users and/or recipients), particularly as compared with merely using a credit card or debit card or performing a person-to-person transaction with which most consumers are familiar.

And, wallets operate entirely at the control and direction of the consumer. There is no (or little) room for error. There is no “help desk” to reach out to if funds go to a wrong location. There is no ability to “reverse the charges” on a mistaken purchase, transfer or exchange. And, if a consumer’s wallet is accessed by another person, an unscrupulous person may transfer all of the consumer’s funds to another cryptographic address effectively without repercussion.

The proliferation of divergent cryptographic currencies is also confusing to an average consumer. Bitcoin is widely known, as are Litecoin and Ethereum. But, beyond that, most consumers have heard nothing of the hundreds of other, potential cryptographic currencies. Some are entirely legitimate and have interesting applications or systems that enable their function. Others are essentially Ponzi schemes, ripe for abuse. The same is true in actual currency exchanges worldwide, but the average consumer does not have as ready access to those exchanges as they have with many cryptocurrencies.

In addition, the Securities and Exchange Commission (SEC) in the U.S. and other regulatory bodies worldwide have significantly cracked down on the various online exchanges to ensure that they comply with know your customer (KYC) regulations associated with securities. These regulations are intended to combat money laundering, but also to ensure that tax policy is followed, to ensure compliance with securities laws, and to avoid the ability to engage in illegal activity using money not traceable to any individual. But, these regulations present a significant hurdle to fast, easy access to cryptocurrency.

These regulations can be dealt with differently. For example, a cryptocurrency company can allow consumers to register for an account, but provide none of the necessary KYC information (e.g., a Social Security number, Driver’s License or other identification). Thereafter, before a consumer can buy, sell, transfer or trade cryptocurrency, these consumers are required to input all of that KYC information of the consumer. These burdens are beneficial for the consumer and the country as a whole, but they present a significant impediment to rapid exchange of cryptocurrency from a user to a recipient. Many consumers do not make it through the registration process.

It is also possible to tackle these and other non-consumer-friendly aspects of the cryptocurrency markets by significantly reducing the complexity for most consumers. A simplification can make cryptocurrency accessible to many who would otherwise be overwhelmed. It is also possible to provide simultaneous investing in multiple coins in a consumer-friendly manner remarkably easy for an average consumer.

However, there are cases when a user may wish to transfer a cryptocurrency to a recipient without engaging in KYC and without even creating a user wallet from which to transfer the cryptocurrency, then another recipient wallet in which to send it. There is also risk in creating a cryptocurrency recipient wallet unattached to the eventual user and that user never accessing the wallet or funds. The transfer of information for that user wallet from the user creator to the end-user recipient may be insecure or intercepted. And, all information necessary for an individual recipient to access that recipient wallet legitimately can likewise be used by another individual to access it for nefarious purposes. Without the KYC information, a third party may never be able to provide cryptocurrency to an individual without some option for an intermediary or other process.

Descriptions herein are of technologies, such as of devices, systems, software and methods for purchasing of and transferring of cryptocurrency without preexisting cryptocurrency wallets. Preexisting user and recipient cryptocurrency wallets may not exist prior to transferring the cryptocurrency to the recipient. For example, purchasing of and transferring may occur prior to user’s or recipient’s entry of know your customer (KYC) information, creation of a cryptocurrency wallet, use of a pre-existing cryptocurrency wallet or use of a pre-existing cryptocurrency wallet address. The recipient may only have to enter any of these to cause the transfer of the cryptocurrency to the recipient’s cryptocurrency wallet.

The technologies may be an ingenious way to remove or reduce the numerous unwanted issues of cryptocurrency purchase and transferring; cryptocurrency non-consumer-friendly features; and the difficult regulatory environment surrounding cryptocurrency. These technologies have the benefits of reducing or removing these unwanted issues. The present technologies have a particular application, for example, in a user gifting of cryptocurrency to a recipient, but may have numerous other applications including person-to-person (e.g., user to recipient) payments or transfers, or in enabling rapid transfer of cryptocurrency from one location to another (e.g., user to user or recipient). These technologies may be described as purchase and transferring of cryptocurrency without preexisting wallets.

### Description of Apparatus

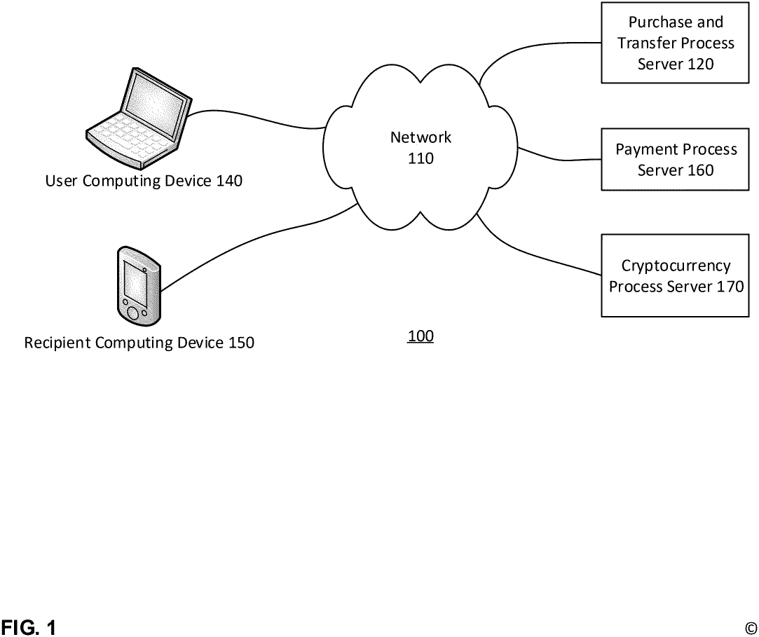

Referring now to FIG. 1, an overview of a system 100 for purchasing of and transferring of cryptocurrency without preexisting cryptocurrency wallets is shown. The system 100 includes a purchase and transfer process server 120, a user computing device 140, a user mobile computing device 150, a payment process server 160 and a cryptocurrency process server 170 all interconnected by a network 110.

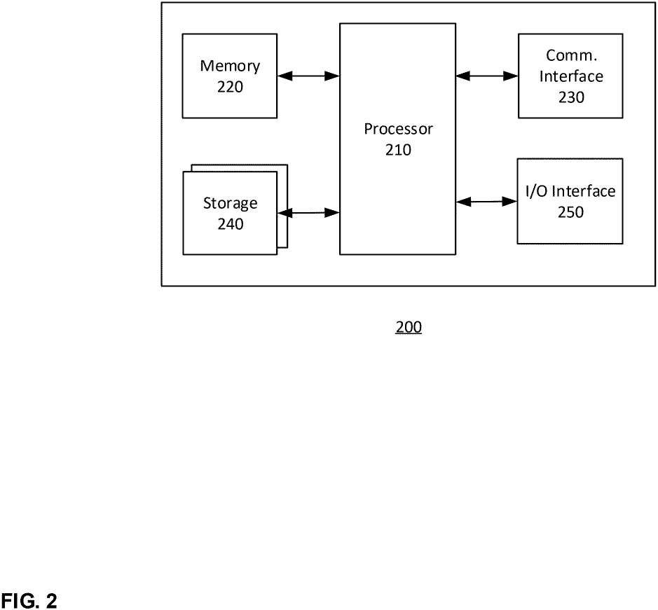

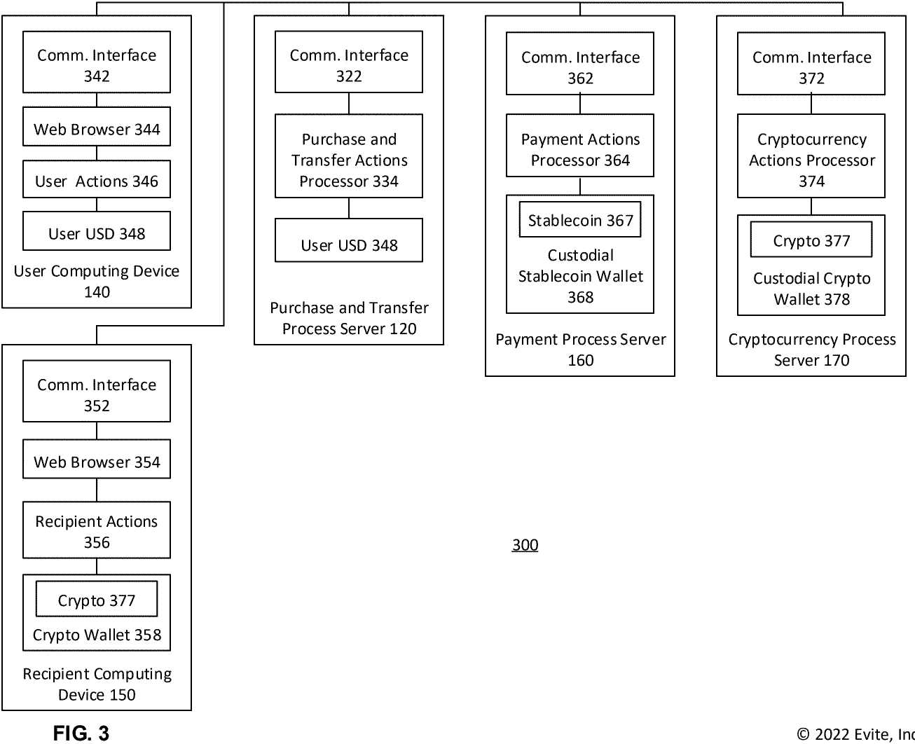

Each of servers 120, 160 and 170 is a computing device (FIG. 2) or a group of computing devices. Each of servers 120, 160 and 170 represents any number of computing devices, cloud devices, servers, and the like. The servers 120, 160 and 170 120 are used to perform the actions of FIGS. 3-8. The actions may include actions of a user purchasing cryptocurrency to be transferred to a recipient; and the recipient redeeming the cryptocurrency and transferring the cryptocurrency to a cryptocurrency wallet of the recipient. The server 120 may receive and take the actions for the user and recipient based on receiving inputs and/or selections of the user actions and recipient actions. The actions of server 120 may include communication with and causing each of servers 160 and 170 to take actions based on the received inputs and/or selections of the user and recipient.

Each of servers 120, 160 and 170 may be self-hosted - meaning operated by a company or entity that enables the functions, processes, methods and systems described herein. Alternatively, each of the servers 120, 160 and 170 may be on a shared resource service such as Amazon AWS or Microsoft Azure. Even more likely, however, each of the servers 120, 160 and 170 is hosted on a high-availability server service—self-hosted or hosted by a service—such as a service typically reserved for conducting monetary transactions and/or purchasing cryptocurrency. Each of servers 120, 160 and 170 may be in a single location, or is in many locations so as to serve the maximum number of users throughout the world quickly and efficiently.

The user computing device 140 is a computing device such as a personal computer, laptop computer, desktop computer, a mobile phone, a smart phone, a tablet computer, or other, similar device. The user computing device 140 is typically a device browsing a website using web browser software or an associated application (e.g., a store or shopping application). The user computing device 140 may be a typical consumer computing device, lacking in any significant specialized capabilities. The user computing device 140 may be used to perform the user actions of FIGS. 3-8. These actions may include actions of a user purchasing cryptocurrency to be transferred to a recipient.

The recipient computing device 150 is effectively identical to the user computing device, though its form factor may be that of a mobile device. This is shown merely as an example, as any device capable of engaging in cryptocurrency transactions may be the recipient computing device 150. The recipient computing device 150 may be used to perform the recipient actions of FIGS. 3-8. These actions may include actions of a recipient redeeming the cryptocurrency and transferring the cryptocurrency to a cryptocurrency wallet of the recipient, such as a wallet on device 150.

FIG. 2 is a block diagram of an exemplary computing device 200, which may be a part of the server 120 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs, instructions and routines for execution by the processor. These instructions may be used to perform the actions of FIGS. 3-8. The actions may include actions of a user purchasing cryptocurrency to be transferred to a recipient; and the recipient redeeming the cryptocurrency and transferring the cryptocurrency to a cryptocurrency wallet of the recipient. The instructions may cause processor 110 to take the actions for the user and recipient based on receiving inputs and/or selections from the user and recipient.

These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals. The word “memory” may also include non-volatile machine-readable mediums for storing a program having instructions, such as to perform the actions of FIGS. 3-8.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi@ wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals. The word “storage” may also include non-volatile machine-readable mediums for storing a program having instructions, such as to perform the actions of FIGS. 3-8.

The input/output interface 250, may include a display and one or more input devices such as a touch screen, keypad, keyboard, stylus or other input devices. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine readable media. These storage media include, for example, magnetic media such as hard disks, optical media such as compact disks (CD-ROM and CD-RW) and digital versatile disks (DVD and DVD±RW), flash memory cards, and other storage media. As used herein, a storage device is a device that allows for reading and/or writing to a storage medium. Storage devices include hard disk drives, DVD drives, flash memory devices, and others.

FIG. 3 is a functional block diagram of a system 300 for purchasing of and transferring of cryptocurrency without preexisting cryptocurrency wallets as shown. The system includes multiple computing devices including the server 120, the user computing device 140, the recipient computing device 150, the server 160 and the server 170. System 300 may be configured to perform the actions of FIGS. 3-8.

The user computing device 140 includes a communications interface 342, a web browser 344, a user actions processor 346 and a user selected amount of USD 348. The communications interface 342 enables network communications with the internet generally, or other networks, but in particular with the servers 120, 160 and 170. The web browser 344 is a typical web browser software which may be stand-alone or integrated into another application or the operating system itself. The user actions processor 346 is configured to receive user inputs and selections; and sends those inputs and selections to the servers. The user actions processor 346 is also configured to receive outputs from the servers; and sends those outputs to user.

The recipient mobile computing device 150 includes its own communications interface 352, a web browser 354, a recipient actions processor 356, a recipient cryptocurrency wallet 358 which may only exist after it is created at device 150. Wallet 358 includes a particular coin of cryptocurrency 377 which only exists after it is transferred from server 170 into the wallet 358. The recipient computing device’s 150 components operate in much the same way as those components of the user computing device 140, except actions processor 356 receives from and outputs to the recipient instead of the user.

The web browsers 344 and 354 are shown as separate components but may be a part of another application (e.g. a stand-alone application used to engage in the purchase and/or redemption of a cryptocurrency) or the mobile device operating system itself.

The server 120 includes a communications interface 322, a purchase and transfer actions processor 334 and a user selected amount of USD 348 (e.g. held in a bank or other account) which may only exist after it is received from device 140. The communications interface 322 is an interface for communicating data to and from the server 120, such as between the server 120 and other computing devices of system 300. It may include hardware (e.g. networking hardware such as wireless or wired network adaptors), but it includes software. The communications interface 322 may incorporate standardized network protocols and software, but also may include specialized calls, interfaces, or APIs (application programming interfaces). At a minimum, the communications interface 322 is configured for responding to HTTP, HTTPS, or other requests for data from the other computing devices of system 300. Interface 322 is configured to receive user and recipient inputs and selections from devices 140 and 150; and to send those inputs and selections to processor 334. It is also configured to send outputs of processor 334 to devices 140 and 150, and to the other servers of system 300.

Processor 334 is configured to receive user and recipient inputs and selections (e.g., through interface 322) from devices 140 and 150, and other inputs from other servers of the system; perform purchase and transfer actions (e.g., processing by processor 334) on those inputs and selections; and send its outputs to other devices of the system, such as noted herein. The processor 334 is also configured to receive outputs from the other servers; perform purchase and transfer actions on those outputs; and send its outputs to other devices of the system, such as noted herein.

The server 160 includes a communications interface 362, a payment actions processor 364, a custodial stablecoin wallet 368 which is not a user or recipient wallet. Wallet 368 includes stablecoin 367 which only exists after it is traded for by server 120. The communications interface 362 is an interface similar to interface 322. Interface 362 is configured to receive user and recipient inputs and selections from devices 140 and 150, and other inputs from other servers of the system; and to send those inputs and selections to processor 364. It is also configured to send outputs of processor 364 to devices 140 and 150, and to the other servers of system 300.

Processor 364 is configured to receive user and recipient inputs and selections (e.g., through interface 362); perform payment actions (e.g., processing by processor 364) on those inputs and selections; and send its outputs to other devices of the system, such as noted herein. The processor 364 is also configured to receive outputs from the other servers; perform payment actions on those outputs; and send its outputs to other devices of the system, such as noted herein.

The server 170 includes a communications interface 372, a cryptocurrency actions processor 374, a custodial cryptocurrency wallet 378 which is not a user or recipient cryptocurrency wallet. Wallet 378 includes cryptocurrency 377 which only exists after it is exchanged for by server 160. The communications interface 372 is an interface similar to interface 322. Interface 372 is configured to receive user and recipient inputs and selections from devices 140 and 150, and other inputs from other servers of the system; and to send those inputs and selections to processor 374. It is also configured to send outputs of processor 374 to devices 140 and 150, and to the other servers of system 300.

Processor 374 is configured to receive user and recipient inputs and selections (e.g., through interface 372); perform cryptocurrency actions (e.g., processing by processor 374) on those inputs and selections; and send its outputs to other devices of the system, such as noted herein. The processor 374 is also configured to receive outputs from the other servers; perform cryptocurrency actions on those outputs; and send its outputs to other devices of the system, such as noted herein.

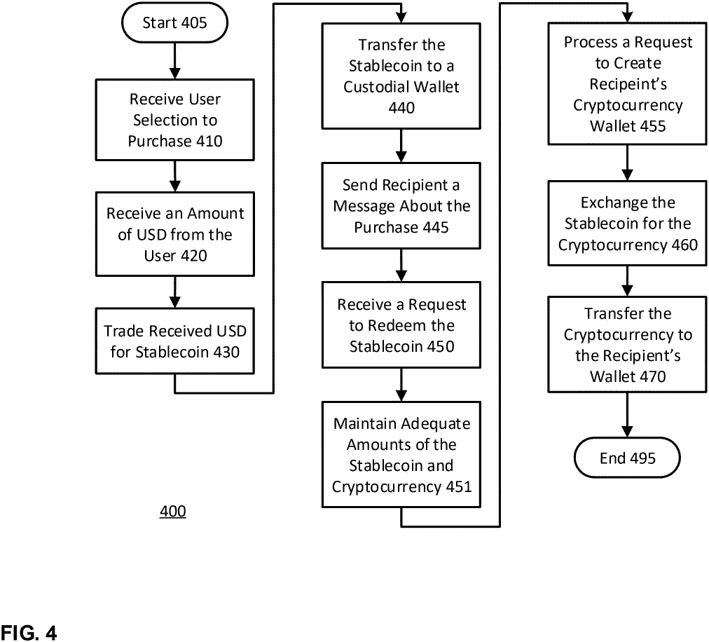

For example, purchase and transfer process server 120 is configured to receive from a user computing device 140, a user-selected amount of United States Dollars (USD) 348 from a user to purchase an exchanged amount of cryptocurrency to transfer to a recipient computing device 150. This receiving may be or include step 420 of FIG. 4.

Being configured to perform a process (e.g., an action) may include having a process to, having logic to, having circuitry to, having a unit to, and/or being for performing that process. For example, processors 346, 356, 334, 364 and 374 are configured to perform user actions, recipient actions, purchase and transfer actions, payment actions, and cryptocurrency actions respectively.

In response to receiving the desired amount of USD 348, server 120 is configured to: trade the received user-selected amount of USD 348 from the user for a desired amount of a stablecoin 367 at a payment process server 160; and transfer the desired amount of stablecoin 367 to an existing custodial wallet 368 to be held for the benefit of the recipient at the server 160. This trading and transferring may be or include steps 430 and 440, respectively, of FIG. 4.

The server 160 is configured to trade the desired amount of a stablecoin 367 for the received user-selected amount of USD 348 from the server 120; and transfer the desired amount of stablecoin 367 to an existing custodial wallet 368 at the server 160 to be held for the benefit of the recipient or until redeemed by the recipient computing device 150.

The server 120 or server 160 is further configured to receive from a recipient computing device 150, process (e.g., by the processor 334 or 364 of the server) and communicate (e.g., transfer or transmit a message having information based on or including the request to redeem) to the server 160, a request to redeem the desired amount of stablecoin 367 held in the custodial wallet 368 for the benefit of the recipient for a cryptocurrency. The request may include a selection of a particular coin of cryptocurrency into which to provide the exchanged amount of cryptocurrency. This receiving may be or include step 450 of FIG. 4.

The server 160 is further configured to, in response to receiving the server 120 communication of the request to redeem: exchange the desired amount of the stablecoin 367 in the existing custodial wallet 368 of the server 160 for an exchanged amount of the particular coin of cryptocurrency 377 at cryptocurrency process server 170. The server 170 is further configured to, in response to receiving the exchange from the server 160, transfer the exchanged amount of the particular coin of cryptocurrency 377 from the server 170 to a recipient-designated wallet address (e.g., of wallet 358) of the recipient computing device 150. In some cases, server 170 transfers currency 377 to a wallet (e.g., created or located) in server 120, server 160, server 170 or device 150. This exchanging of the stablecoin 367 may include minting or creating the exchange amount of the particular coin of cryptocurrency 377. This exchanging and transferring may be or include steps 460 and 470 respectively, of FIG. 4.

The server 120, server 160 or server 170 may be configured to: receive from the recipient computing device 150, process and communicate to the server 170, a request from the recipient computing device 150 to create a recipient’s cryptocurrency wallet 358 at the recipient computing device 150. The wallet 358 having the recipient-designated wallet address and suitable to hold the exchange amount of the particular coin of cryptocurrency 377. This receiving the request may be or include all or parts of step 455 of FIG. 4.

The server 170 is further configured to, in response to receiving the request from the recipient to redeem from the server 120, server 160 or directly to the server 170, create the recipient’s cryptocurrency wallet 358 at the recipient device 150, and transfer the cryptocurrency 377 from the server 170 to the created recipient’s cryptocurrency wallet 358. Creating the recipient’s cryptocurrency wallet 358 may require that the request from the recipient include one of: know your customer (KYC) information, pre-existing cryptocurrency wallet information or using a pre-existing cryptocurrency wallet address. This creating and transferring may include all or parts of steps 455 and 470 respectively, of FIG. 4.

The server 120 may be further configured to: receive from the user computing device 140, a selection from the user to purchase the exchanged amount of the cryptocurrency using the user-selected amount of USD 348 and to transfer the exchanged amount of cryptocurrency 377 to the recipient. This receiving the request may be or include step 410 of FIG. 4.

The server 120 may also be further configured to, in response to receiving the desired amount of USD 348 from the user computing device 140: send a message to the recipient computing device 150 describing the selection from the user to purchase the exchanged amount of the cryptocurrency; maintain at the server 160, adequate available amounts of the stablecoin and maintain at the server 170, adequate available amounts of the particular coin of cryptocurrency to exchange the desired amount of stablecoin 367 for the cryptocurrency 377. This receiving the request may be or include step 445 of FIG. 4.

The server 160 and/or the server 170 are further configured to: determine the exchange amount of the particular coin of cryptocurrency 377 based on the desired amount of stablecoin 367; and ensure that there are adequate available amounts of the stablecoin and of the particular coin of cryptocurrency to exchange the stablecoin 367 for the cryptocurrency 377. This receiving the request may be or include 451 of FIG. 4.

### Description of Processes

Referring now to FIG. 4, a flowchart of a process 400 for purchasing of and transferring of cryptocurrency without preexisting cryptocurrency wallets is shown. The flow chart has both a start 405 and an end 495, but the process may be cyclical in nature by start 405 being performed after end 495.

Process 400 and/or any one or more steps of process 400 may be performed by one or more computing devices, such as devices shown in system 100, device 200 and/or system 300. For instance, it may be performed by servers 160, 170 and/or 120. It may be performed at one or more websites of the one or more devices. A non-volatile machine-readable medium may store at least one program having instructions which when executed by at least one processor will cause the at least one processor to perform the process 400.

Following the start 405, the process begins at step 410 with receiving a selection from a user to purchase an exchange amount of a cryptocurrency and to transfer the exchanged amount of cryptocurrency to a recipient. The selection at step 410 may include receiving from the user a number indicating a desired amount of United States Dollars (USD) to be used to purchase the transfer amount of a cryptocurrency. The selection at step 410 may not include receiving or use of a user’s or a recipient’s cryptocurrency wallet or cryptocurrency wallet address. The selection from the user may include a user’s and a recipient’s name, address, email address and/or phone number. The selection from the user to purchase may include an email address, a phone number or social media address of the recipient. This is helpful in that most users are familiar with each other’s (e.g., and thus the recipient’s) email address, social media address or phone number and name. Step 410 may include device 140 sending and server 120 receiving the selection.

Next at step 420, a user-selected amount of USD is received from a user to purchase the exchanged amount of cryptocurrency to transfer to the recipient. It may be received from the user, such as when the user uses or enters information of a bank account, credit card, or the like. The transfer may utilize a payment process server 140 (FIGS. 1 and 3). Step 420 may include device 140 sending and server 120 receiving the amount.

Steps 410 and 420 may include receiving a user purchase initiated using dollars or other fiat currency. In some cases, the USD may be received from someone other than the user, such as a parent when the user is a minor. At step 420 any one or more of numerous methods may be used for enabling payments or acceptance of payments of fiat currency. For example, at step 420 a credit card processor may process a credit card transaction, and may transfer (or authorize the later transfer) of funds from a credit account to an account of a website accepting those payments. Other purchase systems are envisioned.

In some cases, receiving at step 410 is performed during the same time as and/or same step as receiving at step 420. For example, a webpage may be received has fields filled in by a user with the information received at steps 410 and 420. There may be a submit or enter type button on the page the user clicks to submit the page for receipt.

A fiat currency may be money that is issued and backed by a government, whereas cryptocurrencies may be digital and are not issued by a government, bank, or other central authority. Examples of fiat currencies include the U.S. dollar, the euro, the yen, and most internationally traded currencies. Fiat currency is considered centralized, because these traditional types of currency are typically governed by a single authority. Cryptocurrencies are generally considered decentralized, meaning they rely on blockchain technology and are overseen and managed by a distributed network of computers that may not be owned or operated by any particular entity.

At step 430, in response to receiving the desired amount of USD at step 420, the received user-selected amount of USD from the user is traded for a desired amount of a stablecoin. Step 430 may be converting the money purchase at step 420 converted into U.S. Dollar Coin (USDC) which is a cryptocurrency pegged to the U.S. dollar. In other instances, other stablecoins may also be used instead of USDC. Step 430 may occur automatically (e.g., without receiving any further input or action from the user or recipient) upon occurrence of step 410 and/or step 420. Step 430 may include server 120 and server 160 making the trade.

Step 430 may include, in response to receiving user-selected amount of USD from the user at step 420, determining the desired amount of the stablecoin based on the user-selected amount of USD; and ensuring that there are adequate available amounts of stablecoin to exchange the USD.

As used herein, stablecoin is a cryptocurrency asset that is pegged to a particular metric, currency, or commodity. Stablecoins, at least many stabelcoins, tend to maintain their value over time. There are many examples of stablecoins including USDC (United States Dollar Cryptocurrency) and USDT (TrueUSD), USDT (USD Tether), DAI (Dai), BUSD (Binance USD), but the particular type of stablecoin selected for purposes of this patent is not relevant other than its tendency to maintain its value over time. Stablecoins can be cryptocurrencies where the price is designed to be pegged to a reference asset, hence the term “stable.” For example, if functioning correctly a stablecoin pegged to the U.S. dollar should always be valued at $1. The reference asset may be fiat money, exchange-traded commodities (such as precious metals or industrial metals), or a cryptocurrency. Stablecoins can be blockchain-based payment instruments that aim to eliminate the volatility of cryptocurrencies and to achieve the price stability demanded by end users for payments. Stablecoins can be used for payments. Furthermore, cryptocurrencies such as Bitcoin and altcoins are highly volatile. Holders cannot escape widespread price falls without exiting the market or taking refuge in stablecoins.

So far, stablecoins have seen significant use within the cryptocurrency ecosystem. Yet stablecoins have also been proposed as a payments solution for enterprise blockchain use cases. Stablecoins have solved problems that exist strictly within the cryptocurrency ecosystem, and certain implementations have seen billions of dollars’ worth of daily volume. USDC is a digital dollar, also known as a stablecoin, that’s available 24/7 and moves at internet speed. USDC lives natively on the internet, running on many of the world’s most advanced blockchains. Billions of USDC change hands every day, and every digital dollar of USDC can always be exchanged 1:1 for cash. Other known stablecoin include TrueUSD (TUSD), USD Tether (USDT), Dai (DAI), Binance USD (BUSD),

At step 440 the desired amount of stablecoin is transferred to an existing custodial wallet to be held for the benefit of the recipient. Step 440 may include transferring the desired amount of stablecoin to a custodial wallet address. The custodial wallet may be a trust cryptocurrency wallet held for the benefit of the recipient until such time that the recipient uses a recipient’s cryptocurrency wallet or cryptocurrency wallet address. The custodial wallet is not an account or cryptocurrency wallet of the user or the recipient. It may be a third party wallet. Step 440 may occur automatically upon occurrence of step 410 and/or step 420. Step 440 may include server 120 causing the transfer and/or server 160 making the transfer to wallet 368.

At step 440, the stablecoin money is held in a custodial wallet, such as by a payment or cryptocurrency processor (e.g., server 160). A custodial wallet is a wallet holding cryptocurrency on behalf of others as an intermediate step to reaching those others. This is somewhat like moneys held in trust for the benefit of one or more others that is common, for example, in the legal practice where lawyers can hold client moneys in the name of their clients or for the benefit of their clients.

Unless and until that custodial stablecoin is redeemed (e.g., step 450 or later), it remains in custodial custody. In this way, Securities and Exchange Commission (SEC) regulations regarding knowing one’s customers are always met, because the custodial wallet is already a known customer - it is the custodian (e.g., the payment or cryptocurrency processor). In addition, the conversion of the payment to stablecoin operates to ensure that the same amount (e.g. $50) of U.S. dollar value will be present at the time the currency is redeemed by a recipient.

Importantly, in the checkout process (step 410 and/or step 420), the user may input their own information so as to complete the purchase (e.g. name, address, etc.) and may simultaneously input information for the recipient (e.g. name, address, etc.). In one case, that information will include a name (e.g. John Doe) and an email address and/or phone number associated with John Doe. In the case of a minor, John Doe’s parent’s name and email address and/or phone number may be inputted instead or in addition. Because this basic information is all that is required, the process of purchasing stablecoin and/or transferring cryptocurrency such as noted in process 400 is relatively straightforward for a non-tech-savvy person/user.

None of steps 410, 420, 430 and 440 may include receiving or use of a user’s or a recipient’s cryptocurrency wallet or cryptocurrency wallet address.

At step 445, a message is sent to the recipient describing the selection from the user to purchase the exchanged amount of the cryptocurrency. The message may include identification of a company, identification of a website and/or a hotlink to a website at which to redeem the cryptocurrency. At step 445, the recipient may be notified via the email and/or phone number that they have a gift card or cryptocurrency waiting for them, such as based on the selection at step 410 and/or purchase at step 420. Sending the message may include sending an email, a text message, a social media post or a phone call to the recipient describing the selection of the transfer and the exchange amount of cryptocurrency. Step 445 may occur automatically upon occurrence of step 410 and/or step 420. Step 445 may include any of servers 120 or 160 sending the message to device 150.

Alternatively, step 445 may occur during any of steps 410, 420, 430 or 440.

Thus, the process 400 can take place much more quickly without requiring either of user or recipient to have any cryptocurrency wallet available for transfers at step 440. This ensures that the KYC processes are not yet required, thereby speeding up the entire process. In some cases, the recipient may have a cryptocurrency wallet to redeem the cryptocurrency, but one is not required for the user to make the transfer and send a message to the recipient about the purchase, such as of a gift for the recipient. While the cryptocurrency is held in the custodial wallet, it remains stablecoin such as USDC. Thereafter, the recipient begins the process of redemption of the cryptocurrency (e.g. a gift card, but other transactions are envisioned).

At step 450, a request is received to redeem the desired amount of stablecoin held in the custodial wallet for the benefit of the recipient for a cryptocurrency. Step 450 may include a selection of a particular coin or type of cryptocurrency into which to provide the exchanged amount of cryptocurrency. Step 450 may include device 140 sending and server 120 (and/or server 160) receiving the selection from device 150.

In some cases, the selection of a type of cryptocurrency is made by the user at step 410 or step 420.

At 451, adequate available amounts of the stablecoin and of the particular coin of cryptocurrency are maintained to allow for the exchange the desired amount of stablecoin for the exchange amount of the particular coin of cryptocurrency. Step 451 may occur automatically occurrence of step 410 and/or step 420. Step 451 may include server 160 and/or 170 maintaining.

Step 451 may include determining the exchange amount of the particular coin of cryptocurrency based on the desired amount of stablecoin. The exchange amount of the particular coin of cryptocurrency may be equal in monetary value to the desired amount of stablecoin. In other cases, a processing or other fee may be taken from the desired amount of stablecoin and the monetary value of the exchange amount of the particular coin of cryptocurrency to may be less than that of the monetary value of the desired amount of stablecoin.

Step 451 may include ensuring that that there are adequate available amounts of the stablecoin and of the particular coin of cryptocurrency to make the exchange. Step 451 may include a custodial currency holder or marketplace (e.g., server 160) may ensure that there is adequate currency of the stablecoin and of the particular coin of cryptocurrency available for most transactions on a weekly, daily, hourly or minute-by-minute basis. For example, a balance of $50k in USDC and $50k in wrapped Bitcoin (EGBTC) may be maintained for this purpose. Other currencies may be redeemed as well, in which case other currency balances may be maintained at predetermined levels. The levels may also be based upon the amount of USDC held in custody for others, rising to meet likely demand, and shrinking when demand is no longer present. The levels may be based upon levels of the stablecoin and of the particular coin of cryptocurrency of process 400 for numerous users and recipients. The custodial currency holder (e.g., server 160) may enable automatic maintenance of certain levels of cryptocurrency through the use of smart contracts.

Step 455 is processing a request from the recipient to create a recipient’s cryptocurrency wallet having the recipient-designated wallet address and suitable to hold the exchange amount of the particular coin of cryptocurrency. Processing at 455 may include receiving the request to create the wallet from the recipient. Processing at 455 includes creating the recipient’s cryptocurrency wallet which requires one of: receiving know your customer (KYC) information of the recipient (e.g., a Social Security number, Driver’s License or other identification), using a pre-existing cryptocurrency wallet of the recipient or using a pre-existing cryptocurrency wallet address of the recipient. It may include the recipient creating a recipient cryptocurrency wallet. Step 455 may include device 150 sending and any number of servers 120, 160 and/or 170 receiving and processing the request.

Receiving the KYC information at step 455 may include determining that the KYC information is accurate and valid information, such as by having a legitimate email address, personal address, username, password and the like. If the KYC information is not accurate and valid, the process 400 may discontinue.

In some cases, as a part of that redemption process at step 450, the recipient engage in KYC processes at 455. Otherwise, the recipient cannot access or redeem his or her cryptocurrency. That may be as simple as signing into an existing account with a given cryptocurrency provider (wherein KYC was already completed), or providing a wallet address for an existing wallet if they are savvy enough at 455. However, other cases, at 455, the recipient will be required to open a new account, to provide all of the necessary KYC information, and only thereafter will the redemption process (e.g., transfer at 480) take place.

At step 460, the desired amount of the stablecoin in the existing custodial wallet is exchanged for an exchanged amount of cryptocurrency of the particular coin. Step 460 may occur automatically occurrence of step 445 and 455. Step 460 may include server 160 and 170 exchanging.

Step 460 may occur after transferring at step 440 or receiving a request to redeem at step 450. In other cases, step 460 may occur after step 420 when the user pays the USD and designates some bitcoin or ethereum as the purchase. The cryptocurrency could be purchased right then, such as by performing steps 430-451 and 460 prior to step 455 .

At step 470, the exchanged amount of the particular coin of cryptocurrency is transferred to a recipient-designated wallet address. The wallet address is from or of the wallet of step 455. Step 470 may be transferring to the recipient’s cryptocurrency wallet created at step 455. Step 470 may occur automatically occurrence of step 445 and 455. Step 470 may include server 170 transferring to a wallet created at server 120, server 160, server 170 or device 150.

In some cases, once the KYC is complete at step 455, the recipient’s wallet is identified to the recipient and the wrapped Bitcoin (or other currency) from step 460 is received in that wallet at step 470. After step 470, the user may simply hold the coin (cryptocurrency), may transfer the coin to other wallets, or may do whatever they desire with the coin.

But, importantly, for the transaction to “complete” from the perspective of the user sending the cryptocurrency, no cryptocurrency wallet was required whatsoever. The transaction can be completed by the user in a few, simple steps 410 and 420. From the perspective of the recipient, the “gift” (or transfer) was received immediately (e.g. by email or phone notification) without any need to actually complete KYC until after-the-fact, at step 455. Only upon redemption at step 450 does that process begin.

In some cases, the selection from the user to purchase at step 410 includes a selection to transfer the exchange amount of cryptocurrency as a gift, and the message at step 445 includes a gift card to the recipient for the exchange amount of cryptocurrency.

In some cases, the selection from the user to purchase at step 410 includes a selection to make a direct payment from a credit card to the recipient in the form of the exchange amount of cryptocurrency.

In some cases, the selection from the user to purchase at step 410 includes a selection to make a rapid transfer of the exchanged amount of cryptocurrency from one location to another location of the user. In this way, a purchaser may not need to actually transfer USD, but may merely transfer existing cryptocurrency that is moved from a user’s wallet (identified in the transaction) to a custodial wallet for later redemption.

The cryptocurrency at steps 450-470 may be Bitcoin, Litecoin or Ethereum. Receiving the desired amount of USD from the user at step 420 may include receiving a bank account or credit account number. Maintaining at step 451 or exchanging at step 460 may include creating or minting the exchange amount of the particular coin of cryptocurrency, such as from the desired amount of stablecoin.

In some cases, the cryptocurrency purchase at step 410 is for a particular amount of USD at step 420. In one example of process 400, this is for purposes of enabling the purchase of a gift by the user on behalf of another user, the recipient. But, other transfer types are envisioned such as person-to-person transfers for dinner purchases, large purchases, or to quickly move funds out of a given account and into cryptocurrency without all the processes typically required by wallet-to-wallet transfers (e.g. email or phone number). So, for example, a transfer could be initiated with merely an email or a phone number, with the recipient completing the transaction through the identification of a desired wallet or creation of a new wallet at a later time with the appropriate KYC information.

For example, process 400 may be discussed with reference to a user “gift card” style purchase of cryptocurrency on behalf of another person (the recipient), but it may be as simple as a direct payment from a credit card to another individual in the form of a cryptocurrency purchase, without requiring knowledge of or even existence of any cryptocurrency wallet address associated with the recipient of the cryptocurrency. This is helpful in that most users are familiar with each other’s email address or phone number and name. So, the processes can begin, and even be completed from the user’s perspective, without any particular detailed exchange of information with the recipient being necessary ahead of time.

In some cases, as the recipient redeems the “gift card” (or other transaction) at step 455, the stablecoin held in custody for the redeemer (server 160) is traded for Bitcoin (or another currency) at the then-prevailing exchange of step 460. Because the Bitcoin (or other currency) is held in custody already (at server 160), there are no, or limited, transaction costs to the custodian (server 160). In addition, because the custodian can buy cryptocurrency in bulk (from server 170), the associated transaction costs can be minimized.

In some cases, only steps 420, 430 and 440 are performed. In other cases, steps 450 and 455 are also performed. In other cases, step 460 is performed. Sometimes, any of steps 410, 445 and/or 451 are not performed. All the steps of process 400 may be performed.

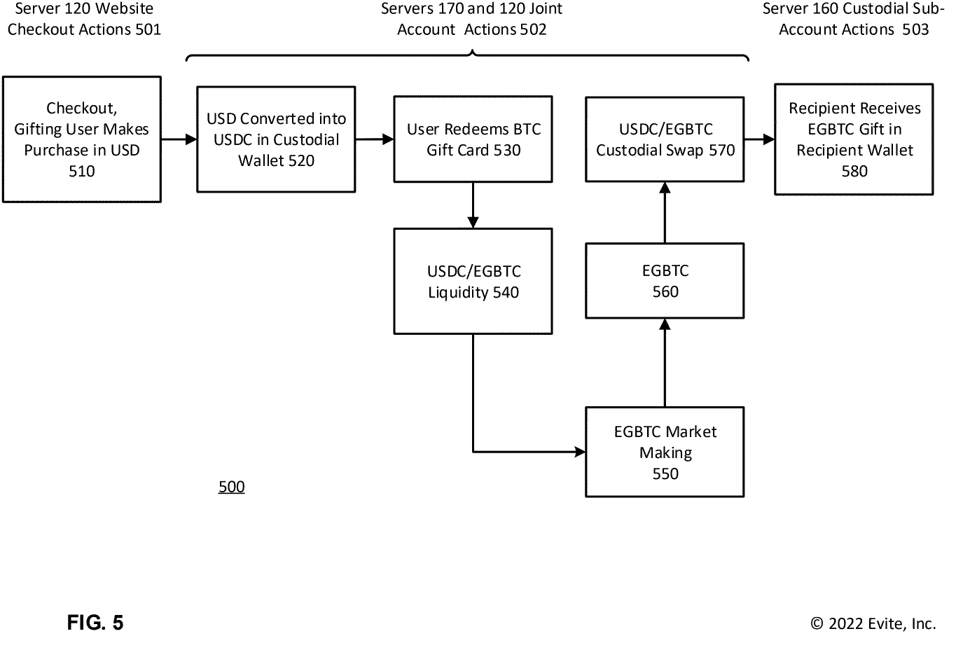

Referring now to FIG. 5, a flowchart of a process 500 for purchasing of and transferring of cryptocurrency without preexisting cryptocurrency wallets as shown. Process 500 may be a gifting flow of funds inter party without preexisting cryptocurrency wallets. The flow chart has both a start at step 510 and an end at step 580, but the process may be cyclical in nature by start step 510 being performed after end step 580.

Process 500 and/or any one or more steps of process 500 may be performed by one or more computing devices, such as devices shown in system 100, device 200 and/or system 300. For instance, it may be performed by servers 160, 170 and/or 120. It may be performed at one or more websites of the one or more devices. A non-volatile machine-readable medium may store at least one program having instructions which when executed by at least one processor will cause the at least one processor to perform the process 500.

Process 500 includes server 120 website checkout actions 501 having step 510, such as performed at least by device 140 and server 120. Process 500 has servers 170 and 120 joint account actions 502 having steps 520 - 570, such as performed at least by servers 120 and 170; and optionally also by device 150 and server 160. Steps 520-570 may use a server 170 and 120 joint pre-existing cryptocurrency wallet or account. Process 500 also has server 160 custodial sub-account actions 503 having step 580, such as performed at least by server 160.

At step 510, a server 120 website checkout occurs, such as by device 140 checking out at server 120. The checkout may be an Evite® website checkout by a gifting user that makes a purchase in USD. Step 510 may be an occurrence of or include parts of steps 410 and 420 where server 120 is an Evite server.

At step 520, the USD purchase from step 510 is converted into USDC in a custodial wallet of server 160 or 170. Step 520 may be an occurrence of or include parts of steps 430 and 440 where the stablecoin is USDC and stablecoin wallet is the wallet of a server 170 and 120 joint account. After step 520 the USDC may be used by the server 170 and 120 joint account to generate a monetary yield, such as by investing the USDC.

At step 530, the user/recipient redeems a Bitcoin (BTC) gift card received from the user via server 120 or 160. Step 530 may be an occurrence of or include parts of steps 445, 450 and 455 where the type of cryptocurrency coin is BTC and the message to the recipient includes a gift card and the redeeming occurs at server 120 or 160.

At step 540, there is USDC and/or EGBTC liquidity. The liquidity may maintain sufficient amounts of the USDC and/or EGBTC for the custodial swap at step 570. The USDC and/or EGBTC liquidity may generate a monetary yield, such as by investing the USDC and/or EGBTC. EGBTC may be a server 170 smart contract token derivative of wBTC generating a yield on DeFi protocols. Step 540 may be an occurrence of or include parts of step 451 where the type of cryptocurrency coin is EGBTC and stablecoin is USDC.

At step 550, there is EGBTC market making. In one example, the wallet custodian maintains both $50k USDC and a $50k EGBTC balances; and the wallet custodian mints EGBTC through server 170 smart contracts to refill the EGBTC balance as needed. Step 550 may be an occurrence of or include parts of step 451 where the type of cryptocurrency coin is EGBTC.

At step 560, the EGBTC is provided for the custodial swap at step 520. The EGBTC at step 550 may be greater than that needed for step 520 due to generate a monetary yield by investing the EGBTC. Step 560 may be an occurrence of or include parts of step 455 where the type of cryptocurrency coin is EGBTC.

At step 570, a USCD to EGBTC custodial swap occurs. The swap may be of the USDC converted into at step 520, prior to its investment and the swap may be of the EGBTC maintained at 540 prior to its investment. Thus, both the USCD to EGBTC investments may provide a yield to server 120, 160 and/or 170 prior to the swap. The yield may be further invested as noted above. Step 570 may be an occurrence of or include parts of step 460 where the stablecoin is USDC and the type of cryptocurrency coin is EGBTC.

At step 580, a server 160 custodial sub-account receives the EGBTC swapped for at step 570. The receiving may be the recipient receiving the EGBTC gift in a server 160 cryptocurrency wallet of or created by the recipient, such as using server 120, 160 and/or 170. Step 580 may include a 90 day lock on the EGBTC gift in the server 160 cryptocurrency wallet such that the recipient can not transfer or use the EGBTC for 90 days. Thus, this EGBTC gift may be further invested for another 90 days by the server having the recipient wallet, such as by generating yield in wBTC while it is held. Step 580 may be an occurrence of or include parts of steps 470 where the type of cryptocurrency coin is EGBTC and the recipient cryptocurrency wallet is at server 170.

Another stablecoin can be used instead of USDC in process 500. Other cryptocurrencies and EGcryptocurrencies can be used instead of BTC and EGBTC in process 500.

During processes herein, such as at any of steps 440-470, 520-580 or 640-670, the USDC may be converted into a synthetic of Bitcoin (e.g., the cyptocurrency) that also generates interest. This bitcoin may sit on the Ethereum blockchain, which lets them lend it out and generate interest. The wrapper lets server 170 (e.g., server 120) collect interest in the meantime. (ERC 20 version of bitcoin). This can be done by creating another wrapper around the cyptocurrency, to be able to lend it out and generate income around it. A smart contract may enable this process and interest generation. Server 170 (e.g., server 120) can also do hedging to avoid loss of value for cyptocurrency coins as they sit prior to redemption. Once redeemed, the coins may just sits there (with no hedging) unless the server invest in an index or hedge (e.g., in Emberfund).

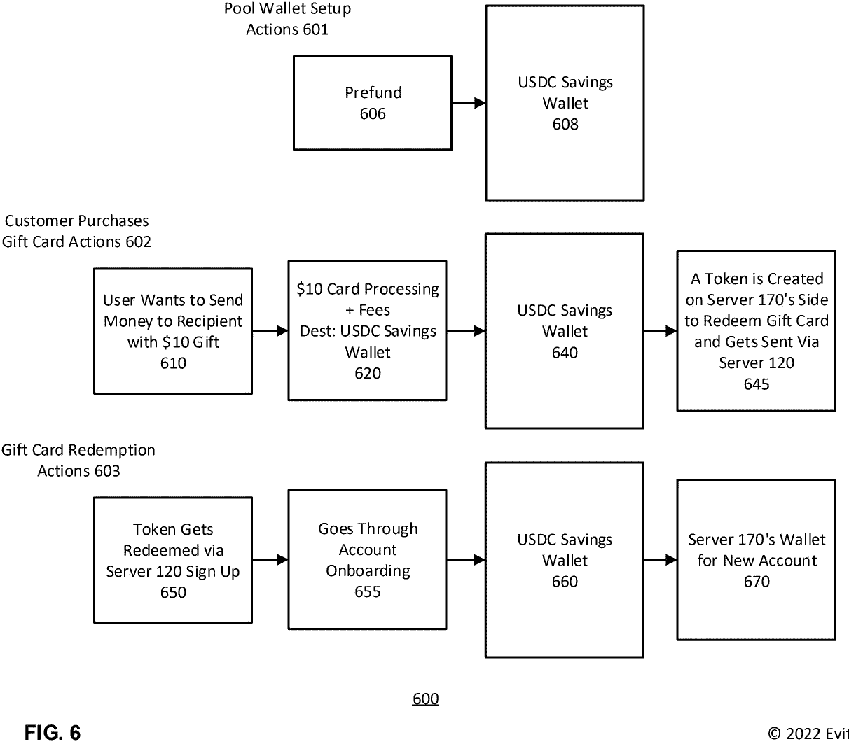

Referring now to FIG. 6, a flowchart of a process 600 for purchasing of and transferring of cryptocurrency without preexisting cryptocurrency wallets as shown. Process 600 may be a funds flow without preexisting cryptocurrency wallets. The flow chart has both a start at step 610 and an end at step 670, but the process may be cyclical in nature by start step 610 being performed after end step 670.

Process 600 and/or any one or more steps of process 600 may be performed by one or more computing devices, such as devices shown in system 100, device 200 and/or system 300. For instance, it may be performed by servers 160, 170 and/or 120. It may be performed at one or more websites of the one or more devices. A non-volatile machine-readable medium may store at least one program having instructions which when executed by at least one processor will cause the at least one processor to perform the process 600.

Process 600 includes pool wallet setup actions having steps 606 and 608, such as performed at least by servers 120, 160 and/or 170. It has customer purchase gift card actions 602 having steps 610, 620, 640 and 645, such as performed at least by servers 120, 150 and 160. It also has gift card redemption actions 603 having steps 650 - 670, such as performed at least by servers 120, 150 and 160.

At step 606, a prefund occurs to a USDC savings wallet. The prefund may include a server performing actions similar or equal to those when executing the computer instructions:

Transfer API
“source”: “paymentmethod:PA_XXX”
“source Currency”; “USDC”
“dest”: “USDC Savings Wallet”
“destCurrency”: “USDC”

Step 606 may be an occurrence of or include parts of step 451, such as including that at least one of servers 120, 160 or 170 prefund the wallet of step 608.

At step 608, the USDC savings wallet to be prefunded is created. The wallet may be one or both of wallets 368 and 378. The creating may include a server performing actions similar or equal to those when executing the computer instructions:

Server 170 API Key
Create Wallet API
“type”: “SAVINGS”

Step 608 may be performed by at least one of servers 120, 160 or 170 and may include accepting the prefund of step 606.

At step 610, a user wants to send money to a friend/recipient , such as with a $10 gift certificate. The money may be sent other than as a gift, as noted herein. The sending may include a server performing actions similar or equal to those when executing the computer instructions:

Evite API Key
Create Wallet Order
Reservation API

Step 610 may create a “reservation id” during executing, such as an address of the wallet created at step 608. Step 610 may be an occurrence of or include parts of step 410, such as including that server 120 receives the user’s wants from device 140.

At step 620, a user purchases USD for the $10 card processing and for additional fees, and the USD has a destination of a USDC savings wallet created at step 608. Step 620 may use the “reservation id” created at 610. The purchase may include a server performing actions similar or equal to those when executing the computer instructions:

Card Process API
“source Currency”; “USD”
“dest”: “USDC Savings Wallet”
“destCurrency”: “USDC”

Step 620 may be an occurrence of or include parts of steps 420 and 430, such as including that server 120 receives the user’s USD from device 140 and trades it for stablecoin/USDC.

At step 640, the USDC from step 620 is deposited into the USDC savings wallet created at step 608. Step 640 may use the “reservation id” created at 610. The depositing may include a server performing some actions similar or equal to those when executing the computer instructions of step 620. Step 640 may be an occurrence of or include parts of steps 430 and/or 440, such as including that server 160 transferring the USDC into the wallet created at step 608.

At step 645, a token is created on server 170 to redeem the gift card of step 620 and the token gets sent via Evite @ to server 120, such as to then be sent to the recipient. Creating the token may include server 170 sending the token to server 120 which sends it to device 150. Step 645 may be an occurrence of or include parts of steps 440 and/or 445, such as including that server 160 transferring the USDC into the wallet created at step 608 and/or sending a message to the recipient.

At step 650, the token from step 645 gets redeemed via Evite® server 120 sign up by the recipient. Redeeming the token may include server 120 receiving receiver cryptocurrency wallet information or creation from device 150. Step 650 may be an occurrence of or include parts of steps 450 and/or 455, such as by being part of creating the recipient wallet.

At step 655, the redeeming at step 650 goes through account onboarding, such as to verify that the receiver cryptocurrency wallet information is accurate and authorized. If so, the cryptocurrency may be deposited in the recipient’s wallet at steps 660-670. Onboarding may include server 120, 160 and/or 170 receiving receiver cryptocurrency wallet information and performing the verification. The onboarding may include a server performing actions similar or equal to those when executing the computer instructions:

Trigger Transfer API

Step 655 may be an occurrence of or include parts of steps 450 - 460, such as by being part of creating the recipient wallet and exchanging the USDC/stablecoin for the cryptocurrency, such as WBTC2 cryptocurrency.

At step 660, the USDC deposited in the savings wallet at 640 is exchanged for the cryptocurrency (e.g., WBTC2) from step 655. Step 660 may deposit the cryptocurrency into the recipient wallet created at steps 650-655. The depositing may include a server performing some actions similar or equal to those when executing the computer instructions:

Transfer API
“source”: “USDC Savings Wallet”
“source Currency”; “USDC”
“dest”: “Server 170‘s Wallet”
“destCurrency”: “WBTC2”

Step 660 may be an occurrence of or include parts of steps 460 and/or 470, such as including that servers 160 and 170 transfer the cryptocurrency into the recipients wallet.

At step 670, the server 170’s wallet for a new account of the recipient receives the cryptocurrency from step 660. Step 670 may include the cryptocurrency from step 660 being deposited in the recipient’s wallet and being accessible to the recipient. Step 670 may deposit the cryptocurrency into the recipient wallet created at steps 650-655. Step 670 may be an occurrence of or include parts of step 470, such as including that device 150 or server 170 receives the transferred cryptocurrency in the recipient’s wallet.

Another stablecoin can be used instead of USDC in process 600. Other cryptocurrencies, wCoins and wCoins2 can be used instead of BTC, wBTC and wBTC2 in process 600.

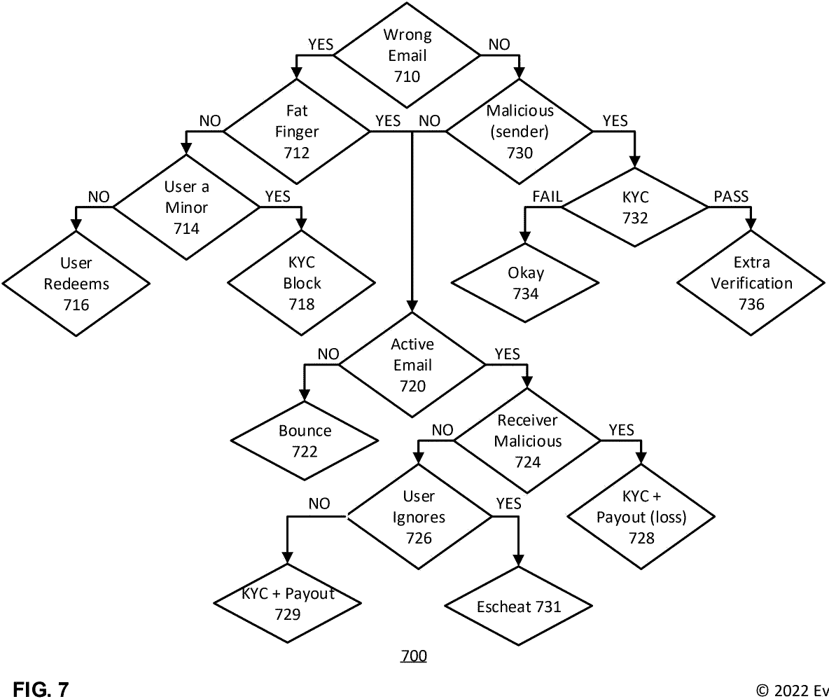

Referring now to FIG. 7, a flowchart of a process 700 for purchasing of and transferring of cryptocurrency without preexisting cryptocurrency wallets as shown. Process 700 may be a wrong email flow without preexisting cryptocurrency wallets. This is a flow for the communication with an individual for whom cryptocurrency has been purchased in the process of attempting to complete the purchase on their behalf. The flow chart has both a start at step 710 and ends at steps 716, 718, 72, 726, 728, 734 or 736, but the process may be cyclical in nature by start step 6710 being performed after any of the end steps.

Process 700 and/or any one or more steps of process 700 may be performed by one or more computing devices, such as devices shown in system 100, device 200 and/or system 300. For instance, it may be performed by servers 160, 170 and/or 120. It may be performed at one or more websites of the one or more devices. A non-volatile machine-readable medium may store at least one program having instructions which when executed by at least one processor will cause the at least one processor to perform the process 700. Process 700 may be included as part of any of steps 410, 420, 445, 450, 455 or a corresponding step of FIGS. 5, 6 or 8.

At step 710, an email is received by any of the servers (e.g., server 120, 160 or 170). Upon receipt of the email, the server determines at step 710 if the email (or an email address in the received email, such as an email address of the recipient in an email from the user) is a wrong email, such as an email that has erroneous information such as an unknown, incorrect or invalid email address, username, password or KYC information. If the email has erroneous information, the process continues to step 712, if not the process continues to step 730.

At step 712, the server (e.g., any of server 120, 160 or 170) determines if the erroneous information is due to a “fat finger” error. The fat finger error may be detected by determining that the error is due to a keyboard or touchscreen input or key that is immediately adjacent to a correct input or key that would correct the error. If there is a fat finger error, the process continues to step 720, if not the process continues to step 714.

At step 714, the server determines if the user (e.g., user or recipient for any of FIGS. 5, 6 or 8) is a minor. Determining if the user is a minor may be based upon receiving information that indicates the user’s age is below the age of adulthood or majority (or is emancipated), such as based on inputs or selections at any of steps 410, 420, 445, 450, 455 or a corresponding step of FIGS. 5, 6 or 8. If the user is a minor, the process continues to step 718, if not the process continues to step 716.

At step 716, the server allows the user to redeem successfully, such as to have the cryptocurrency transferred to the recipient’s wallet (e.g., as in step 470 or steps including step 470).

At step 718, the server performs a KYC block of the user redemption, such as by not transferring the cryptocurrency to the recipient’s wallet (e.g., not performing step 470 or steps including step 470). Step 718 may include the server requiring input of valid KYC information for redemption and blocking redemption if the input KYC information is not valid or accurate because redemption by a minor is not possible under some regulations.

At step 720, the server determines if the email address of the received email at step 710 (or an email address in the received email, such as an email address of the recipient in an email from the user) is an active email, such as by known processes like looking up the email address in email or browser databases. If the email address is an active email, the process continues to step 724, if not the process continues to step 722.

At step 722, the server bounces the email received email at step 710, such as by known processes like sending a message to the user with a copy of the email and discontinuing the current process and/or email transmission.

At step 724, the server determines if the receiver is malicious. Step 724 may include determining if the recipient email address of the received email at step 710 (or an email address in the received email, such as an email address of the recipient in an email from the user) is a known malicious address, such as by known processes like looking up the email address in email or browser databases. If the receiver is malicious, the process continues to step 728, if not the process continues to step 726.

At step 726, the user ignores the email, such as by the server discontinuing the current process and/or email transmission. Here, the process merely stalls, but after a set amount of time has elapsed, then the money may effectively escheat to the cryptocurrency custodial wallet holder at 731. If the user does not ignore the email, then KYC and payout occur at 729.

At step 728, the KYC and payout are allowed, such as by the server allowing the user to redeem successfully, such as to have the cryptocurrency transferred to the recipient’s wallet (e.g., as in step 470 or steps including step 470). This payout may be a loss to the finances at the server because the funds are transferred out.

At step 730, the server determines if the email sender (e.g., the user of FIGS. 4-6 and 8) is malicious. Step 730 may include determining if the sender email address of the received email at step 710 is a known malicious address, such as by known processes like looking up the email address in email or browser databases. If the sender is malicious, the process continues to step 732, if not the current process continues.

At step 732, the server requests and receives KYC information. Receiving the KYC information at step 732 may include determining that the KYC information is accurate and valid information, such as by having a legitimate email address, personal address, username, password and the like. If the KYC information is accurate and valid, the process continues to step 736, if not the current process continues to step 734.

At step 734 the failure of the KYC information is okay and the server performs a KYC block of the user redemption, such as by not transferring the cryptocurrency to the recipient’s wallet (e.g., not performing step 470 or steps including step 470).

At step 736, the server requests and receives extra verification when sending off to server 170, such as at steps 455-470 and steps including those steps. Alternatively or in addition, step 736 may include locking up the user access to the server for a number of days, such as 7, 30 or 90 days.

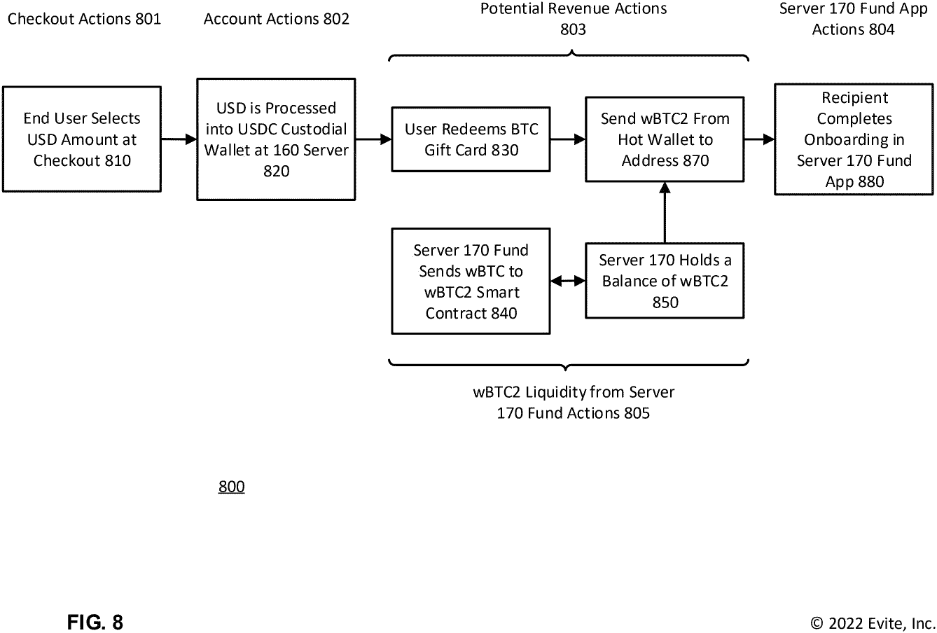

Referring now to FIG. 8, a flowchart of a process 800 for purchasing of and transferring of cryptocurrency without preexisting cryptocurrency wallets as shown. Process 800 may be an Evite@ funds flow without preexisting cryptocurrency wallets. The flow chart has both a start at step 810 and an end at step 880, but the process may be cyclical in nature by start step 810 being performed after end step 880.

Process 800 and/or any one or more steps of process 800 may be performed by one or more computing devices, such as devices shown in system 100, device 200 and/or system 300. For instance, it may be performed by servers 160, 170 and/or 120. It may be performed at one or more websites of the one or more devices. A non-volatile machine-readable medium may store at least one program having instructions which when executed by at least one processor will cause the at least one processor to perform the process 800.

Process 800 includes checkout actions 801 having step 810, such as performed at least by device 140 and server 120. Process 800 includes account actions 802 having step 580, such as performed at least by servers 120 and 160. Process 800 includes potential revenue actions 803 having steps 830 and 870, such as performed at least by servers 120 and 170; and optionally also by device 150 and server 160. Process 800 also has server 170 fund application actions 804 having step 880, such as performed at least by server 170. Also, process 800 has wBTC2 liquidity from server 170 fund actions 805 having steps 840 and 850, such as performed at least by server 160 and /or 170.

At step 810, an end user selects a USD amount at checkout, such as by device 140 checking out at server 120. Step 810 may be an website checkout. Step 810 may include or be part of steps 410 and 420; or step 510. The USD at step 810 may be converted from other domestic and/or international charges. Server 120 can use the step 810 as a revenue opportunity, such as by charging the user a percentage markup on the exchange rate to convert to USD; by charging a flat fee or variable fee to checkout or exchange; and/or by passing fees required by server 160 actions along and adding a markup. The checkout may require basic user information (basic KYC) as noted for step 410.

At step 820, USD (e.g., from a credit card) is processed into a USDC custodial wallet such as at server 160. A Card Proc API may be used to process into USDC at step 820. Step 820 may include or be part of steps 430, 440 and 445; or step 520. At step 820, the USDC balance may be used to fund wBTC2 redemptions.

At step 830, a user redeems a BTC gift card, such as such as the recipient redeeming from device 150. Step 830 may include or be part of steps 450, 451 and 455; or step 530. At step 830, the USDC balance may be deducted. Server 120 can use the step 830 as a revenue opportunity, such as by charging the recipient to checkout or exchange as noted for charging the user at step 810.

At step 840, a server 170 fund sends wBTC to a wBTC2 smart contract. Step 840 may be initiated at or after step 830. Step 840 may include or be part of step 540.

At step 850, a server 170 holds a balance of wBTC2, such as according to the smart contract. Step 850 may include setting threshold alerts to reliquidate the balance of wBTC2 depending on the smart contract terms, such as based on whether a value of an investment of the received wBTC2 is decreasing below a threshold. Step 850 may include or be part of step 550.

Step 840 may be part of a relationship with step 850 where step 840 sends wBTC2 to step 850 and in return step 850 holds a balance of the wBTC2 and returns wBTC, USDC or USD profits due to the smart contract terms, such as based on investing the received wBTC2. Thus, server 120 can use the steps 840 and 850 as a revenue opportunity, such as by collecting the wBTC, USDC or USD profits.

At step 870, server 170 send the wBTC2 from the hot wallet at step 850 to an address, such as of the recipient’s cryptocurrency wallet, such as at device 150. A server 160 fund at step 830 may pass the wallet address via an API to the server 170. Step 870 may be sending a value of the wBTC2 that is based on or equal to the value of USD (e.g., minus fees) at step 810 that the user wants to send or gift to the recipient. Step 870 may include or be part of steps 460 and 470; or steps 570 and 580.

At step 880, the recipient completes onboarding in server 170 fund app. Step 880 may include the recipient receiving the wBTC2 or another coin of cryptocurrency selected by the recipient at an address of the recipient’s cryptocurrency wallet, such as at device 150. Step 880 may include or be part of steps 455 - 470; or step 580.

Another stablecoin can be used instead of USDC in process 800. Other cryptocurrencies, wCoins and wCoins2 can be used instead of BTC, wBTC and wBTC2 in process 800.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for, purchasing of and transferring of cryptocurrency without preexisting cryptocurrency wallets comprising:
a first computing device configured to:
receive from a user computing device, a user-selected amount of United States Dollars (USD) from a user to purchase an exchanged amount of cryptocurrency to transfer to a recipient;
in response to receiving the desired amount of USD:
trade the received user-selected amount of USD from the user for a desired amount of a stablecoin at a second computing device; and
transfer the desired amount of stablecoin to an existing custodial wallet to be held for the benefit of the recipient at the second computing device;
the second computing device configured to:
trade the desired amount of a stablecoin for the received user-selected amount of USD from the first computing device; and
transfer the desired amount of stablecoin to an existing custodial wallet at the second computing device to be held for the benefit of the recipient.

2. The system of claim 1, the first computing device further configured to:
receive from a recipient computing device, process and communicate to the second computing device, a request to redeem the desired amount of stablecoin held in the custodial wallet for the benefit of the recipient for a cryptocurrency, wherein the request includes a selection of a particular coin of cryptocurrency into which to provide the exchanged amount of cryptocurrency.

3. The system of claim 2, the second computing device further configured to, in response to receiving the first computing device communication of the request to redeem:
exchange the desired amount of the stablecoin in the existing custodial wallet of the second computing device for an exchanged amount of cryptocurrency of the particular coin at third computing device; and
the third computing device further configured to, in response to receiving the exchange,
transfer the exchanged amount of the particular coin of cryptocurrency from the third computing device to a recipient-designated wallet address of the recipient computing device.

4. The system of claim 3, wherein the cryptocurrency is one of Bitcoin, Litecoin or Ethereum; wherein receiving the desired amount of USD from the user includes receiving a bank account or credit account number; and wherein exchanging includes minting the exchange amount of the particular coin of cryptocurrency.

5. The system of claim 1, the first computing device further configured to:
receive from the recipient computing device, process and communicate to the third computing device, a request from the recipient computing device to create a recipient’s cryptocurrency wallet at the recipient computing device having the recipient-designated wallet address and suitable to hold the exchange amount of the particular coin of cryptocurrency; and
the third computing device further configured to, in response to receiving the request from the recipient,
create the recipient’s cryptocurrency wallet, and
transfer the exchange amount of the particular coin of cryptocurrency from the third computing device to the created recipient’s cryptocurrency wallet at the recipient computing device.

6. The system of claim 5, wherein creating the recipient’s cryptocurrency wallet requires that the request from the recipient include one of: know your customer (KYC) information, pre-existing cryptocurrency wallet information or using a pre-existing cryptocurrency wallet address.

7. The system of claim 1, the first computing device further configured to:
receive from a user computing device, a selection from the user to purchase the exchanged amount of the cryptocurrency using the user-selected amount of USD and to transfer the exchanged amount of cryptocurrency to the recipient.

8. The system of claim 1, the first computing device further configured to, in response to receiving the desired amount of USD from the user computing device:
send a message to the recipient computing device describing the selection from the user to purchase the exchanged amount of the cryptocurrency; maintain at the second server, adequate available amounts of the stablecoin and maintain at the third computing device, adequate available amounts of the particular coin of cryptocurrency to exchange the desired amount of stablecoin for the exchanged amount of the particular coin of cryptocurrency.

9. The system of claim 8, wherein the selection from the user to purchase the exchange amount includes a selection to transfer the exchange amount as a gift, and wherein the message includes a gift card to the recipient for the exchange amount of cryptocurrency.

10. The system of claim 1, one of the second computing device or the third server further configured to:
determine the exchange amount of the particular coin of cryptocurrency based on the desired amount of stablecoin; and
ensure that there are adequate available amounts of the stablecoin and of the particular coin of cryptocurrency to exchange the desired amount of stablecoin for the particular coin of the exchanged amount of cryptocurrency.

11. At least one non-volatile machine-readable medium storing at least one program having instructions which when executed by at least one processor will cause the at least one processor to:
receive a user-selected amount of United States Dollars (USD) from a user to purchase an exchanged amount of cryptocurrency to transfer to a recipient;
in response to receiving the desired amount of USD:
trade the received user-selected amount of USD from the user for a desired amount of a stablecoin; and
transfer the desired amount of stablecoin to an existing custodial wallet to be held for the benefit of the recipient.

12. The instructions of claim 11, which when executed further cause the at least one processor to:
receive a request to redeem the desired amount of stablecoin held in the custodial wallet for the benefit of the recipient for a cryptocurrency, wherein the request includes a selection of a particular coin of cryptocurrency into which to provide the exchanged amount of cryptocurrency.

13. The instructions of claim 12, which when executed further cause the at least one processor to:
exchange the desired amount of the stablecoin in the existing custodial wallet for an exchanged amount of cryptocurrency of the particular coin, and
transfer the exchanged amount of the particular coin of cryptocurrency to a recipient-designated wallet address.

14. The instructions of claim 13, wherein the cryptocurrency is one of Bitcoin, Litecoin or Ethereum; wherein receiving the desired amount of USD from the user includes receiving a bank account or credit account number; and wherein exchanging includes minting the exchange amount of the particular coin of cryptocurrency.

15. The instructions of claim 14, which when executed further cause the at least one processor to:
process a request from the recipient to create a recipient’s cryptocurrency wallet having the recipient-designated wallet address and suitable to hold the exchange amount of the particular coin of cryptocurrency;
create the recipient’s cryptocurrency wallet, and
transfer the exchange amount of the particular coin of cryptocurrency to the created recipient’s cryptocurrency wallet.

16. The instructions of claim 15, wherein creating the recipient’s cryptocurrency wallet requires one of: receiving know your customer (KYC) information, using a pre-existing cryptocurrency wallet or using a pre-existing cryptocurrency wallet address.

17. The instructions of claim 11, which when executed further cause the at least one processor to:
receive a selection from the user to purchase the exchanged amount of the cryptocurrency using the user-selected amount of USD and to transfer the exchanged amount of cryptocurrency to the recipient.

18. The instructions of claim 11, which when executed further cause the at least one processor to, further in response to receiving the desired amount of USD:
send a message to the recipient describing the selection from the user to purchase the exchanged amount of the cryptocurrency; maintain adequate available amounts of the stablecoin and of the particular coin of cryptocurrency to exchange the desired amount of stablecoin for the exchanged amount of the particular coin of cryptocurrency.

19. The instructions of claim 18, wherein the selection from the user to purchase the exchange amount includes a selection to transfer the exchange amount as a gift, and wherein the message includes a gift card to the recipient for the exchange amount of cryptocurrency.

20. The instructions of claim 11, which when executed further cause the at least one processor to, further in response to receiving one of the user-selected amount of USD from the user or the selection from the recipient to redeem:
determine the exchange amount of the particular coin of cryptocurrency based on the desired amount of stablecoin; and
ensure that there are adequate available amounts of the stablecoin and of the particular coin of cryptocurrency to exchange the desired amount of stablecoin for the particular coin of the exchanged amount of cryptocurrency.

21. The instructions of claim 11, wherein the selection from the user to purchase the exchange amount includes a selection to make a direct payment from a credit card to the recipient in the form of the exchange amount of cryptocurrency.

22. The instructions of claim 11, wherein the selection from the user to purchase the exchange amount includes a selection to make a rapid transfer of the exchange amount of cryptocurrency from one location to another location of the user.

23. A method for creation and transfer of cryptocurrency without preexisting cryptocurrency wallets, the method comprising:
receiving a user-selected amount of United States Dollars (USD) from a user to purchase an exchanged amount of cryptocurrency to transfer to a recipient;
in response to receiving the desired amount of USD:
trading the received user-selected amount of USD from the user for a desired amount of a stablecoin; and
transferring the desired amount of stablecoin to an existing custodial wallet to be held for the benefit of the recipient.

24. The method of claim 23, further comprising:
receiving a request to redeem the desired amount of stablecoin held in the custodial wallet for the benefit of the recipient for a cryptocurrency, wherein the request includes a selection of a particular coin of cryptocurrency into which to provide the exchanged amount of cryptocurrency, wherein creating the recipient’s cryptocurrency wallet requires one of: receiving know your customer (KYC) information, using a pre-existing cryptocurrency wallet or using a pre-existing cryptocurrency wallet address.
